(19) United States
(12) Patent Application Publication
(10) Pub. No.: US 2023/0281047 A1
(43) Pub. Date: Sep. 7, 2023

(54) HARDWARE ACCELERATION OF EXPLAINABLE MACHINE LEARNING

(71) Applicant: University of Florida Research Foundation, Incorporated, Gainesville, FL (US)

(72) Inventors: Prabhat Kumar Mishra, Gainesville, FL (US); Zhixin Pan, Gainesville, FL (US)

(21) Appl. No.: 18/178,945

(22) Filed: Mar. 6, 2023

Related U.S. Application Data
(60) Provisional application No. 63/317,242, filed on Mar. 7, 2022.

(51) Int. Cl. G06F 9/50; G06F 15/80

(52) U.S. Cl. CPC G06F 9/5027; G06F 15/80

(57) ABSTRACT

Various embodiments provide methods, apparatuses, computer program products, systems, and/or the like for an efficient framework that enables explainability machine learning for various machine learning-based tasks. In various embodiments, the framework for explainable ML is configured for acceleration and efficient computing using hardware accelerators. To provide acceleration of explainable ML, various embodiments exploit synergies between convolution operations for data objects (e.g., matrix, images, tensors, arrays) and Fourier transform operations, and various embodiments apply these synergies in hardware accelerators configured to perform such operations. Accordingly, various embodiments of the present disclosure may be applied in order to provide real-time or near real-time outcome interpretation in various machine learning-based tasks. Extensive experimental evaluations demonstrate that various embodiments described herein can provide drastic improvement in interpretation time (e.g., 39× on average) as well as energy efficiency (e.g., 69× on average) compared to existing techniques.

### CROSS-REFERENCE TO A RELATED APPLICATION

This application claims the benefit of U.S. Provisional Application Ser. No. 63/317,242, filed Mar. 7, 2022, the content of which is hereby incorporated by reference in its entirety, including all figures, tables, and drawings.

### GOVERNMENT SUPPORT PARAGRAPH

This invention was made with government support under 1908131 awarded by National Science Foundation. The government has certain rights in the invention.

### TECHNOLOGICAL FIELD

The present disclosure generally relates to the technical field of hardware implementation of machine learning-based tasks, such as classification, prediction, detection, generation, and/or the like. In particular, embodiments of the present disclosure relate to computational and operational efficiency of hardware processing components that are used to apply machine learning to such tasks, as well as to explainability of the function of the machine learning in such tasks.

### BACKGROUND

Various embodiments of the present disclosure address technical challenges relating to performance of hardware processing components that may be employed for computational operations in machine learning-based tasks. Various embodiments additionally address technical challenges relating to providing explainability for machine learning in its applied tasks, such as classification, prediction, detection, generation, and/or the like.

### BRIEF SUMMARY

While machine learning (ML) has generally been successful in achieving human-level performance in various fields, ML lacks the ability to explain an outcome due to its black-box nature. Existing efforts to develop explainable ML are not applicable in real-time systems since they map explainability and interpretability as an optimization problem, which leads to numerous iterations of time-consuming complex computations. Even worse, existing explainable ML implementations are not particularly amenable or compatible with accelerated hardware components, such as field programmable gate arrays (FPGAs), graphics processing units (GPUs), tensor processing units (TPUs), and/or the like.

Accordingly, various embodiments of the present disclosure provide an efficient framework that provides explainability machine learning for various machine learning-based tasks. In various embodiments, the framework for explainable ML is configured for acceleration and efficient computing using hardware accelerators, including the aforementioned FPGAs, GPUs, TPUs, and/or the like. In providing acceleration of explainable ML, the framework exploits synergies between convolution operations for data objects (e.g., matrix, images, tensors, arrays) and Fourier transform operations, and the framework applies these synergies in hardware accelerators configured to perform such operations. For instance, some example hardware accelerators may be specialized and efficiently operated for matrix-based operations. Accordingly, various embodiments of the present disclosure may be applied in order to provide real-time or near real-time outcome interpretation in various machine learning-based tasks. Extensive experimental evaluations demonstrate that various embodiments described herein can provide drastic improvement in interpretation time (e.g., 39× on average) as well as energy efficiency (e.g., 69× on average) compared to existing techniques.

### BRIEF DESCRIPTION OF THE DRAWINGS

Having thus described the present disclosure in general terms, reference will now be made to the accompanying drawings, which are not necessarily drawn to scale.

FIG. 1 provides a diagram illustrating end-to-end use and benefits of explainable machine learning in ML-based tasks.

FIGS. 2A and 2B provide diagrams depicting example accelerated hardware elements that may be used to implement various embodiments described herein.

FIG. 3 provides a diagram illustrating example concepts relating to explainable machine learning, in accordance with various embodiments of the present disclosure.

FIG. 4 illustrates an example decision tree used in a Shapley value analysis explainability technique in accordance with various embodiments of the present disclosure.

FIG. 5 provides a schematic of a computing entity that may be used in conjunction with various embodiments of the present disclosure.

FIG. 6 provides an overview diagram illustrating an example framework for accelerating hardware performance for providing explainable machine learning, in accordance with various embodiments of the present disclosure.

FIG. 7 illustrates example operations performed with accelerated hardware elements to provide efficient computing performance, in accordance with various embodiments of the present disclosure.

FIG. 8 illustrates experimental results related to accelerated performance of different accelerated hardware elements enabled through various embodiments of the present disclosure.

FIG. 9 illustrates experimental results related to improved power consumption of different accelerated hardware elements enabled through various embodiments of the present disclosure.

FIG. 10 illustrates experimental results related to improved operational efficiency and throughput of different accelerated hardware elements enabled through various embodiments of the present disclosure.

FIG. 11 illustrates experimental results related to the provision of explainability and interpretability in an example ML-based task.

FIG. 12 illustrates experimental results related to the provision of explainability and interpretability in another example ML-based task.

FIG. 13 illustrates experimental results related to the application of Shapley value analysis explainability techniques, in accordance with various embodiments of the present disclosure.

FIG. 14 illustrates experimental results related to the application of integrated gradient explainability techniques, in accordance with various embodiments of the present disclosure.

### DETAILED DESCRIPTION OF SOME EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### General Overview and Exemplary Technical Improvements

Machine learning (ML) techniques, which are powered by deep neural network machine learning models in various examples, are pervasive across various application domains. Recent advances in ML techniques have enabled promising performance with outstanding flexibility and generalization. However, existing ML techniques are not able to interpret the outcome (e.g., explain its output) since it produces the outcome according to model operations and computations inside a “black-box”. This lack of transparency severely limits the applicability of ML. In many applications, a designer or user can act judiciously if an ML model can provide an outcome as well as an interpretation of the outcome. For example, during malware detection using an ML model, it is important to know whether a software is malicious or benign as well as the rationale for such a classification. Moreover, the interpretation of the results is crucial to enable the localization (e.g., clock cycle and specific reason) of the malicious activity in a malware, in these examples. Other applications and tasks, such as image classification and/or the like, also significantly benefit from interpretability of machine learning outputs.

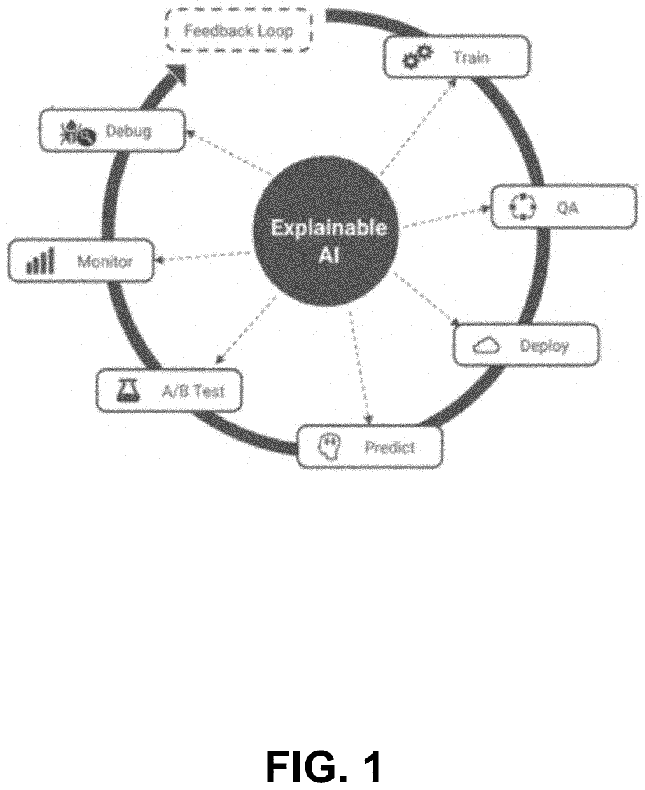

Various embodiments are directed to providing explainable ML in order to enable outcome interpretation in such applications and tasks. By providing interpretation of input-output mapping and clues for importance ranking of input features, the explainable ML acts like another supervisor to guide the learning process and bring extra information to users. Explainable ML can be adopted in many application domains and can be used in an end-to-end manner in an application and/or development pipeline, as shown in FIG. 1. For example, during the training of a facial recognition classifier, if information about which region in the face distinguishes the target from the others can be obtained, the corresponding weight can be adjusted to emphasize features collected from that region. Accordingly, various embodiments described herein that provide explainable ML result in technical improvements in accuracy for various ML-based tasks, as explainable ML can assist in the development, configuration, and optimization of ML models for the various ML-based tasks.

Further, various embodiments described herein enable provision of explainable ML in a feasible and efficient manner. Existing explainable ML techniques are inherently inefficient and are not applicable in real-time applications and systems. In particular, existing explainable ML techniques treat the explanation process as an extra procedure on top of the actual inference procedure and performs the explanation process outside the learning model, thereby generating inefficiencies in practice. Additionally, existing explainable ML techniques solve a complex optimization problem that consists of numerous iterations of time-consuming computations. As a result, such time-consuming interpretation is not suitable for time-sensitive applications with soft or hard deadlines. In soft real-time systems, such as multimedia and gaming devices, inefficient interpretation can lead to unacceptable Quality-of-Service (QoS). In hard real-time systems, such as safety-critical systems, missing task deadlines can lead to catastrophic consequences.

To address these technical challenges relating to providing explainable ML, various embodiments described herein provide for hardware acceleration of explainable machine learning. Various embodiments provide an efficient framework to achieve fast explainable ML that can utilize various hardware accelerators, including field programmable gate arrays (FPGAs), Graphic Processing Units (GPU), Tensor Processing Units (TPU), Accelerated Processing Units (APUs), Integrated Graphic Processing Units (IGPUs), and/or the like. In the present disclosure, such hardware accelerators may be generally referred to interchangeably as accelerated hardware elements.

Various embodiments described herein include transforming an explainable ML procedure into matrix-based operations, and the matrix-based operations can be performed fast, efficiently, and in parallel across a number of accelerated hardware elements. In various embodiments, matrix-based operations for an input are distributed across a number of accelerated hardware elements, and the outputs of the number of accelerated hardware elements are aggregated and combined to achieve a result in an efficient manner. In various embodiments, the accelerated hardware elements are configured (and specialized for) the matrix-based operations. For example, a GPU comprises a large number of cores and high-speed memory for performing efficient matrix computation and parallel computing. Similarly, for example, a TPU is an Application Specific Integrated Circuit (ASIC) developed specifically to accelerate the computations in deep neural networks, with extremely high throughout and fast performance with low memory footprint. Thus, the efficient framework can be realized through use of such example accelerated hardware elements, as well as other conceivable accelerated hardware elements.

### Exemplary Accelerated Hardware Elements

As identified within the present disclosure, examples of accelerated hardware elements may include field programmable gate arrays (FPGAs), graphics processing units (GPUs), tensor processing units (TPUs), accelerated processing units (APUs), vision processing units (VPUs), quantum processing units (QPUs), and/or the like. While any example accelerated hardware element may be used in accordance with various embodiments described herein, the present disclosure discusses GPUs and TPUs herein. Generally, GPUs and TPUs have been recognized as suitable and competitive in ML-based tasks and machine learning applications.

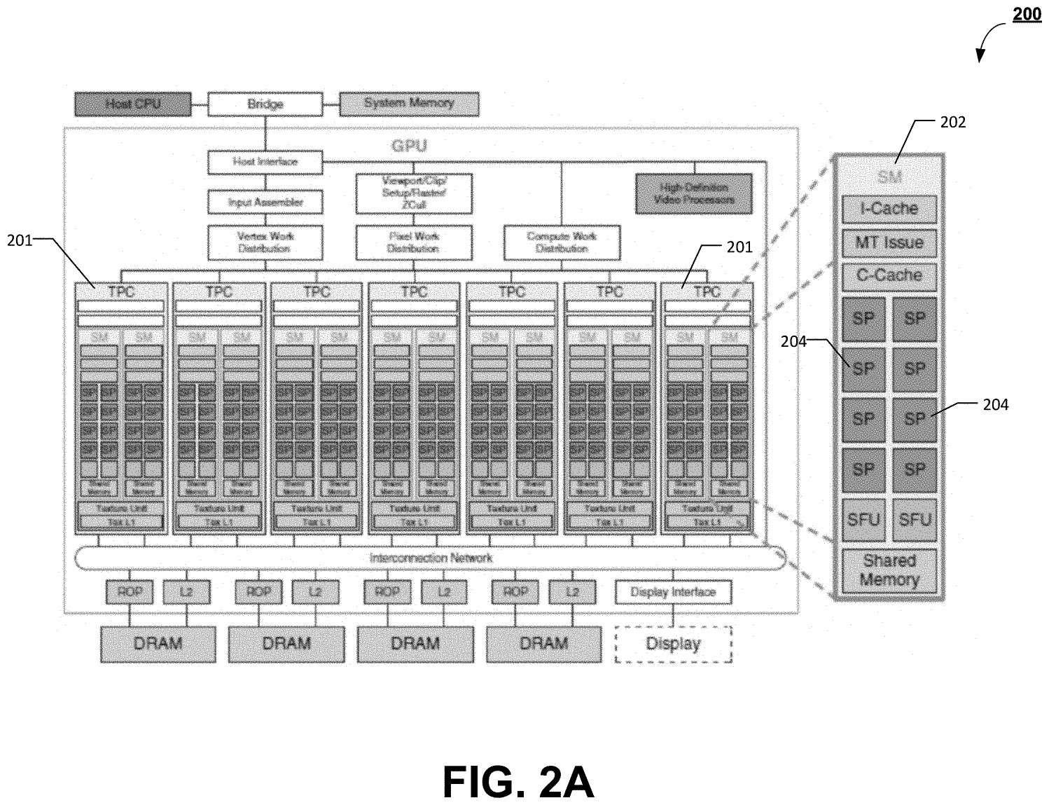

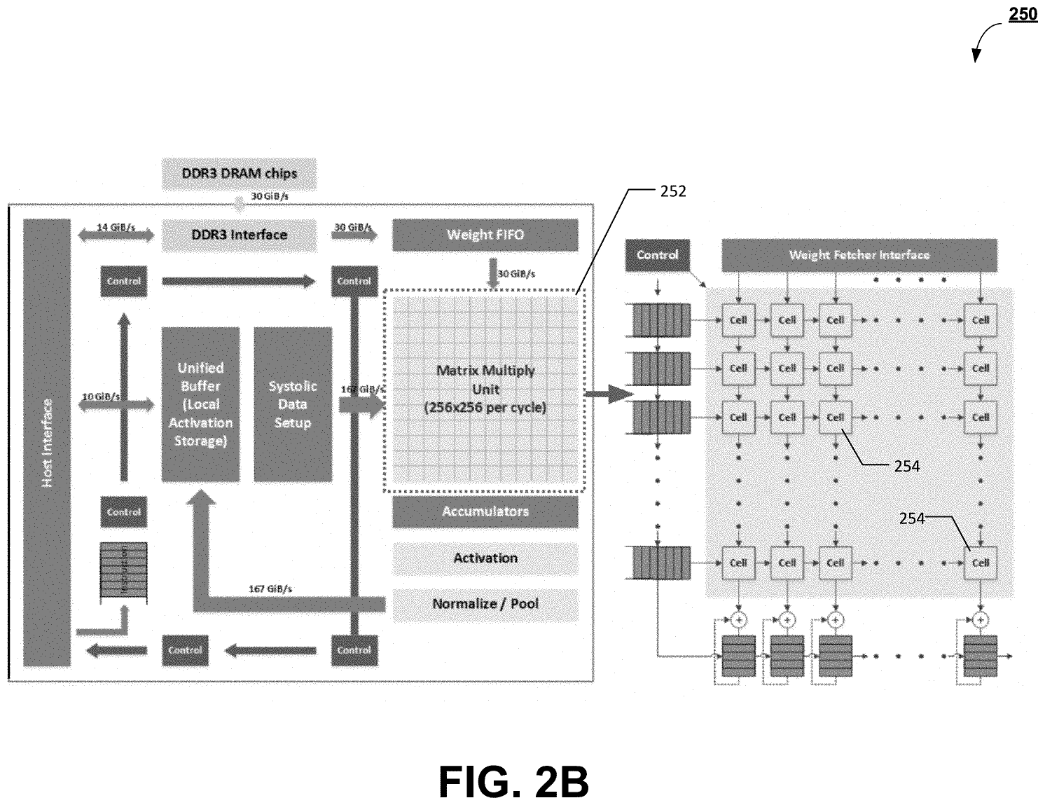

Referring first to FIG. 2A, an example diagram of a GPU 200 is provided. As illustrated in FIG. 2A, the GPU 200 comprises a large number of computing units, or cores, and long pipelines. For example, in the illustrated embodiment, the GPU 200 comprises a plurality of streaming processors 204 (e.g., representing cores of the GPU 200) organized into a plurality of shared multiprocessors 202, each of which having one or more memory portions (e.g., partitions) of the GPU 200 to use a SM-specific shared memory, SM-specific caches, and/or the like. In some examples, the GPU 200 comprises one or more processing clusters 201 (e.g., texture processing clusters, or TPCs) each comprising one or more shared multiprocessors 202. Accordingly, in various example embodiments, the GPU 200 comprises a hierarchical organization with a plurality of cores (e.g., streaming processors 204) at its foundation, and in various embodiments, computational operations may be distributed and assigned in a parallel at any level of the hierarchical organization (e.g., at a cluster-level, at a multiprocessor-level, at a core-level, and/or the like).

With its configuration, such as the one shown in FIG. 2A, the GPU 200 provides advantages over a central processing unit (CPU) and is more suitable for a large number of parallel computing tasks. For examples, the parallel computing tasks can be distributed among the computing units or the cores of the GPU 200 such that the tasks can effectively be performed in parallel. In various embodiments, the parallel computing tasks include matrix-based operations (e.g., matrix multiplication), convolution operations, and/or the like, which may be integral to deep learning algorithms. In various embodiments, the GPU 200 provides a hardware-based acceleration that delivers superior performance compared to software-based acceleration via a CPU, due at least in part to its utilization of multi-core parallel computing of neural network data with multi-threading, its higher memory access speed, and its floating-point computing capabilities.

The tensor processing unit (TPU) provides a different example of an accelerated hardware element, and FIG. 2B illustrates an example architecture of a TPU 250. In various examples, the TPU 250 is a domain-specific hardware for accelerating the computation process of deep learning models. Superior performance of TPUs 250 over CPUs may be due at least in part to quantization and utilization of systolic arrays in TPUs 250. Quantization is the first step of optimization, which uses 8-bit integers to approximate 16-bit or 32-bit floating-point numbers. This can reduce an amount of memory capacity and computing resources of the TPU 250 that are required for processing data. A systolic array is a major contributor to the efficiency of the TPU 250 due to its natural compatibility with matrix manipulation coupled with the fact that computation in neural networks can be represented as matrix operations.

In various embodiments, the core of the entire TPU is represented by a Matrix Multiply Unit, or MXU 252. The MXU 252 is a systolic array with dimensions 256×256 and composed of multiple computation cells 254. Each cell 254 receives a weight parameter along with an input signal at a time and performs accumulation of their products. Once all weights and input signals are propagated to neighboring cells, for example top to bottom and left to right respectively, the MXU 252 immediately starts the next round of computations. As a result, an entire matrix multiplication operation can be completed by the collaboration of all computation cells within the MXU 252. The systolic array of the MXU 252 comprises 65,536 arithmetic logic units, or ALUs (65,536=256*256), which means that the TPU 250 can process 65,536 8-bit integer multiplications and additions per cycle. Due to the systolic architecture, input data can be reused for multiple times. Therefore, the TPU 250 can achieve higher throughput while consuming less memory bandwidth. In various embodiments, a TPU 250 may comprise one or more MXUs 252 to further expand its capabilities.

As discussed, various embodiments of the present disclosure exploit unique capabilities of accelerated hardware elements, such as GPU 200 and TPU 250, for efficient computations for providing explainable machine learning in ML-based tasks. Through the use of accelerated hardware elements in accordance with various embodiments described herein, explainable machine learning and/or similar computationally-intensive procedures can be performed with improved speed, throughput, and efficiency. For example, beyond explainable machine learning procedures in accordance with embodiments of the present disclosure, various embodiments described herein enable improved acceleration of other procedures including scheduling optimization, mathematical algorithms, image reconstruction, automatic path-finding, and/or the like.

### Exemplary Concepts for Explainable Machine Learning

The demand for explainable ML has been steadily increasing ever since machine learning has been widely adopted in many fields, especially in security domains, and various embodiments address various technical challenges related to providing explainability in ML-based tasks. The present disclosure herein introduces some example explainable machine learning concepts that generally may be applied in various embodiments. For example, various embodiments may apply one or more explainable machine learning concepts related to model distillation, Shapley analysis, and/or integrated gradients (IGs).

In general, explainable ML is directed to providing interpretable explanations for results output by a machine learning model (e.g., an artificial and/or a deep neural network ML model, a convolutional neural network ML model, a recurrent neural network ML Model, a graph neural network ML model, a transformer- and/or an encoder-based ML model, and/or the like). Specifically, given an input instance x and an ML model M, the ML model M will generate a corresponding output y for x during the testing time, thus acting as a classifier for example.

Explanation techniques then aim to illustrate why the input instance x is transformed into y. This often involves identifying a set of important features that make key contributions to the forward pass or inference of the ML model M. If the selected features are interpretable by human analysts, then these features can offer an “explanation”.

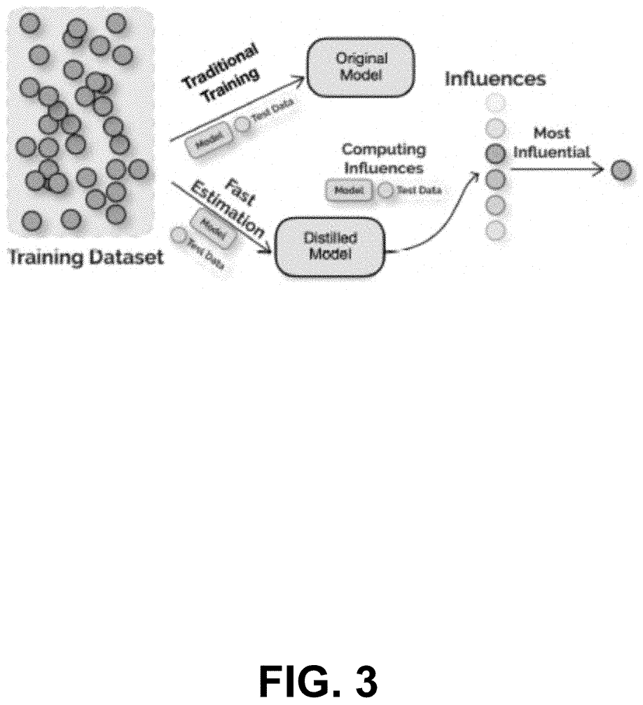

In various embodiments of the present disclosure, model distillation serves as one explainable ML technique. The basic idea of model distillation is that it develops a separate model that may be referred to as a “distilled model” to be an approximation of the input-output behavior of the target machine learning model (e.g., ML model M). This distilled model, denoted as M*, is usually chosen to be inherently explainable by which a user is able to identify the decision rules or input features influencing the outputs of the target machine learning model. Model distillation is generally depicted in FIG. 3, and in various embodiments, model distillation is composed of three major steps: (i) model specification, (ii) model computation, and (iii) output interpretation.

Model Specification: The type of distilled model has to be specified at first. This often involves a challenging tradeoff between transparency and expression ability. A distilled model that is relatively complex can offer better performance in mimicking the behavior of original model M. However, increasing complexity also leads to the inevitable drop of model transparency, with the distilled model itself becoming hard to explain, and vice versa. Further, increased complexity of the distilled model results in increased computational requirements and efforts in an explainable ML procedure.

Model Computation: Once the type and/or an architecture of the distilled model M* is determined and corresponding input-output pairs from the target machine learning model (e.g., ML model M) are provided, the model computation task aims at searching for optimal parameters θ for M* using Equation 1, which is an optimization problem. In various embodiments, the parameters θ may include coefficients (e.g., linear regression coefficients), weights, biases, hyperparameters, and/or the like. In Equation 1, x represents inputs provided to the target machine learning model, and y represent the corresponding outputs generated by the target machine learning model (x and y forming the input-output pairs).

$$θ = arg {min}_{θ} ‖ {M}^{*} ( x ) ‖ - y \qquad Equation 1$$

Outcome Interpretation: Based on the computed distilled model, the explanation arrives from measuring the contribution of each input feature in producing the result (e.g., a classification, a prediction, a regeneration, and/or the like). For instance, the distilled model can be specified as a linear regression model and expressed as a polynomial. Then, by sorting the terms of the polynomial according to the amplitude of the associated coefficients computed during model computation, crucial information is obtained. For example, the input features found to be most discriminatory can be identified, as can features or output correlations relevant for classification or generally, the function or application of the target machine learning model. In some example embodiments, model distillation with the distilled model being specified as a linear regression model can be approximately embodied by saliency map techniques. While interpretation and analysis of the distilled model M* may not explicitly provide insights into the internal representation of the original machine learning model or explicitly demonstrate the original machine learning model's learning process, model distillation provides at least insight into correlations that explain how the original machine learning model makes a decision.

In various embodiments of the present disclosure, Shapley analysis (SHAP) serves as another explainable ML technique. The core idea of SHAP is similar to model distillation. SHAP aims to illustrate the major reason a model transfers certain input into the predictions generated by the model by identifying the important features that make key contributions to the forward pass of the model. SHAP embodies the concept of Shapley values which draw correlations to cooperative game theory. Shapley values are used to fairly attribute a “player's” contribution to the end result of a “game.” SHAP captures the marginal contribution of each player to the final result. Formally, the marginal contribution of the i-th player to the game can be calculated by:

$${∅}_{i} = {\sum }_{S ⊆ \frac{N}{\{ i \}}} \frac{\vert S \vert ! ( M - \vert S \vert - 1 ) !}{M !} [ {f}_{x} ( S ⋃ \{ i \} ) - {f}_{x} ( S ) ] \qquad Equation 2$$

where the total number of players is |M|. S represents any subset of players that does not include the i-th player, and ƒₓ(⋅) represents the function to give the game result for the subset S. Intuitively, Shapley values are a weighted average payoff gain that player i provides if added into every possible coalitions without i.

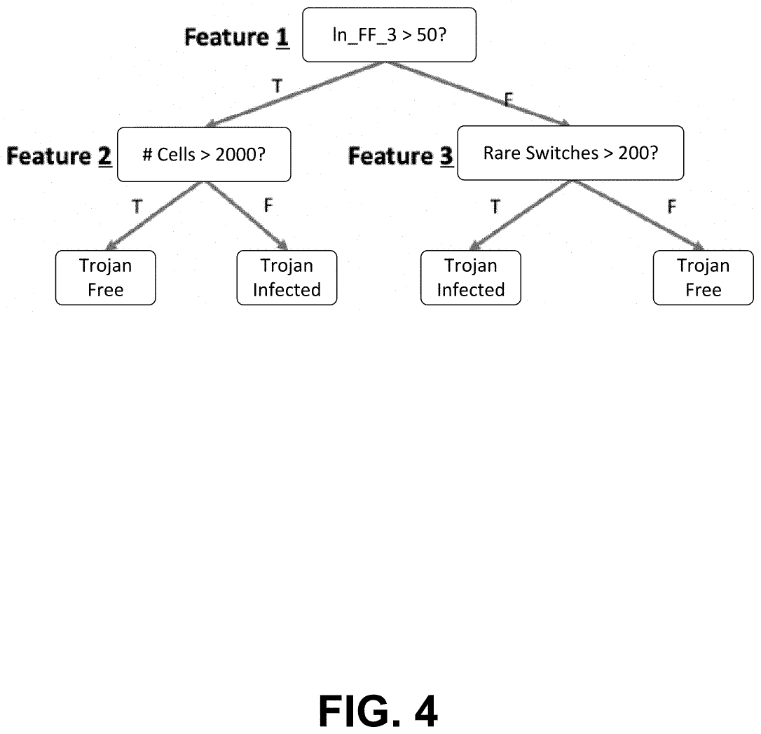

To apply SHAP in ML tasks, we can assume features as the players in a cooperative game. SHAP is a local feature attribution technique that explains every prediction from the model as a summation of each individual features' contributions. Assume a decision tree is built with three different features for hardware trojan (HT) detection as shown in FIG. 4. To compute Shapley values, a null model without any independent features is initialized. Next, a payoff gain is computed as each feature is added to the null model in a sequence. Finally, an average is computed over all possible sequences. As depicted in the example in FIG. 4, with three independent variables, 3!=6 sequences must be considered. The computation process for the SHAP value of the first feature is presented in Table I below.

TABLE 1
Marginal contributions of the first feature for the model.

| Sequences | Marginal Contributions |
|---|---|
| 1, 2, 3 | [symbol] ({1}) − [symbol] (0) |
| 1, 3, 2 | [symbol] ({1}) − [symbol] (0) |
| 2, 1, 3 | [symbol] ({1, 2]) − [symbol] ({2}) |
| 2, 3, 1 | [symbol] ({1, 2, 3}) − [symbol] ({2, 3}) |
| 3, 1, 2 | [symbol] ({1, 3}) − [symbol] ({3}) |
| 3, 2, 1 | [symbol] ({1, 2, 3}) − [symbol] ({3, 2}) |

Here, [symbol] is the loss function. The loss function serves as the ‘score’ function to indicate how much payoff is currently accrued by applying existing features. For example, in the first row, the sequence is 1, 2, 3, meaning the first, the second, and the third features are sequentially added into consideration for classification. Ø stands for the model without considering any features, which in the current example is a random guess classifier, and [symbol] (Ø) is the corresponding loss. Then, by adding the first feature into the scenario, {1} can be used to represent the dummy model that only uses this feature to perform prediction. The loss [symbol] {1} is then computed again. [symbol] {1}− [symbol] (Ø) is the marginal contribution of the first feature for this specific sequence. The Shapley values for the first feature are obtained by computing the marginal contributions of all six sequences and taking the average Similar computations happen for the other features.

In various embodiments of the present disclosure, Integrated Gradients (IG) serves as another technique to explain ML models. The equation to compute the IG attribution for an input record x and a baseline record x′ is as follows:

$${IG}_{i} ( x ) := ( {x}_{i} - {x}_{i}^{′} ) \times {\int }_{α = 0}^{1} \frac{\partial F ( {x}^{′} + α \times ( x - {x}^{′} ) )}{\partial {x}_{i}} d α \qquad Equation 3$$

where F: [symbol] ⁿ→[0, 1] represents the ML model,

$$\frac{\partial F ( x )}{\partial {x}_{i}}$$

is the gradient of F(x) in the i-th dimension. Informally, IG defines the attribution of the i-th feature xᵢ from input as the integral of the straight path from baseline x′ to input x. Compared to various other explainable AI algorithms in this field of study, IG satisfies many desirable axioms that are particularly important for an ML explanation method, namely the completeness axiom and the sensitivity axiom. The completeness axiom generally describes that given x and a baseline x′, the attributions of x add up to the difference between the output of F at the input x and the baseline x′. The sensitivity axiom generally described that for every input and baseline that differ in one feature but have different predictions, the differing feature should be given a non-zero attribution. Various embodiments described herein provide explainable ML procedures that can be performed with improved efficiency, while maintaining reliability in demonstrating the correlations that explain decisions made by a ML model. With the improved efficiency provided by various embodiments described herein, explainability and interpretability can be integrated into real-time or near real-time ML-based systems, which further augments the capabilities, effectiveness, and potential applicability of machine learning in various technical fields.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

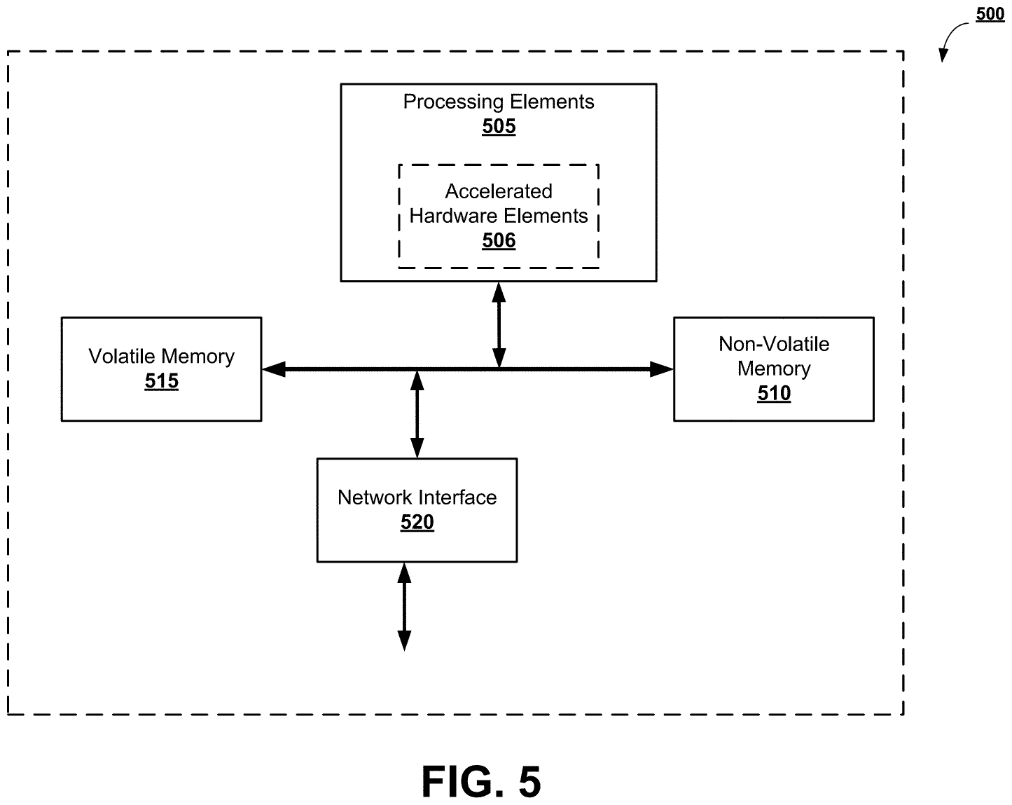

FIG. 5 provides a schematic of an exemplary computing entity 500 that may be used in accordance with various embodiments of the present disclosure. In particular, the computing entity 500 may be configured to perform various example operations described herein to provide explainable machine learning via efficient use and recruitment of accelerated hardware elements. In various embodiments, the computing entity 500 is configured to distribute various parallel computing tasks for providing explainable machine learning to different accelerated hardware elements, and to reassemble outputs of the different accelerated hardware elements to generate an explainable AI model (XAI) model that provides explainability and interpretability of a target machine learning model.

In general, the terms computing entity, entity, device, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. Although illustrated as a single computing entity, those of ordinary skill in the field should appreciate that the computing entity 500 shown in FIG. 5 may be embodied as a plurality of computing entities, systems, devices, and/or the like operating collectively to perform one or more processes, methods, and/or steps.

Depending on the embodiment, the computing entity 500 may include one or more communications and/or network interfaces 520 for communicating with various computing entities, such as by communicating data, content, information, and/or similar terms used herein interchangeably that can be transmitted, received, operated on, processed, displayed, stored, and/or the like. Thus, in certain embodiments, the computing entity 500 may be configured to receive data from one or more data sources and/or devices as well as receive data indicative of input, for example, from a device. In various embodiments, the computing entity 500 may receive input-output pairs and/or other data associated with a target machine learning model via a network interface 520, such that the computing entity 500 uses the received data to efficiently provide explainability and interpretability for the target machine learning model.

The networks used for communicating may include, but are not limited to, any one or a combination of different types of suitable communications networks such as, for example, cable networks, public networks (e.g., the Internet), private networks (e.g., frame-relay networks), wireless networks, cellular networks (e.g., 4th generation long term evolution cellular networks, 5th generation new radio cellular networks), telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 500 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), New Radio (NR), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 500 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the computing entity 500 includes or is in communication with one or more processing elements 505 (also referred to as processors, processing circuitry, and/or similar terms used herein interchangeably) that communicate with other elements within the computing entity 500 via a bus, for example, or network connection. As will be understood, the processing elements 505 may be embodied in several different ways. For example, the processing elements 505 may be embodied as one or more complex programmable logic devices (CPLDs), microprocessors, multi-core processors, coprocessing entities, application-specific instruction-set processors (ASIPs), and/or controllers. Further, the processing element 505 may be embodied as one or more other processing devices or circuitry. The term circuitry may refer to an entirely hardware embodiment or a combination of hardware and computer program products. Thus, the processing elements 505 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 505 may be configured for a particular use or configured to execute instructions stored in volatile or non-volatile media or otherwise accessible to the processing elements 505. As such, whether configured by hardware, computer program products, or a combination thereof, the processing elements 505 may be capable of performing steps or operations according to embodiments of the present disclosure when configured accordingly.

In particular, as illustrated in FIG. 5, the processing elements 505 include one or more accelerated hardware elements 506, in various embodiments. Examples of accelerated hardware elements 506, as previously identified, may include field programmable gate arrays (FPGAs), graphics processing units (GPUs), tensor processing units (TPUs), accelerated processing units (APUs), vision processing units (VPUs), quantum processing units (QPUs), and/or the like. In various embodiments, the accelerated hardware elements 506 may be particularly configured and specialized for efficiently performing high-volume computations, such as matrix-based operations (e.g., matrix multiplication, convolution). Accordingly, the computing entity 500 is configured to recruit and use the one or more accelerated hardware elements 506 to efficiently perform various example operations discussed herein, and in particular, the one or more accelerated hardware elements 506 are used to efficiently provide explainability and interpretability for a target machine learning model. In some example embodiments, the one or more accelerated hardware elements 506 are also used to execute the target machine learning model itself.

In various embodiments, the computing entity 500 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 510 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 510 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In particular embodiments, the non-volatile memory media 510 may also be embodied as a data storage device or devices, as a separate database server or servers, or as a combination of data storage devices and separate database servers. Further, in some embodiments, the non-volatile memory media 510 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments described herein use data storage in which some or all the information/data required for various embodiments of the disclosure may be stored.

In various embodiments, the computing entity 500 may further include or be in communication with volatile media (also referred to as volatile storage, memory, memory storage, memory circuitry and/or similar terms used herein interchangeably). For instance, the volatile storage or memory may also include one or more volatile storage or volatile memory media 515 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like.

As will be recognized, the volatile storage or volatile memory media 515 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 505. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 500 with the assistance of the processing element 505 and operating system.

As will be appreciated, one or more of the computing entity's components may be located remotely from other computing entity components, such as in a distributed system. Furthermore, one or more of the components may be aggregated, and additional components performing functions described herein may be included in the computing entity 500. Thus, the computing entity 500 can be adapted to accommodate a variety of needs and circumstances.

### Exemplary Framework and Operations

Various embodiments of the present disclosure are directed to providing explainable machine learning in an efficient manner via accelerated hardware elements 506, also referred to herein interchangeably as hardware acceleration of explainable machine learning. In particular, efficiency provided by various embodiments described herein enables generation and provision of explainability data and interpretability data in ML-based tasks, and in particular, in real-time or near real-time ML-based tasks. Explainability data is associated with significant importance in ML-based tasks in various technical fields. Returning to a previously-identified example, it may be important to identify which specific traces or signal components that are provided to a detection ML model cause a given detection result to be output by the detection ML model.

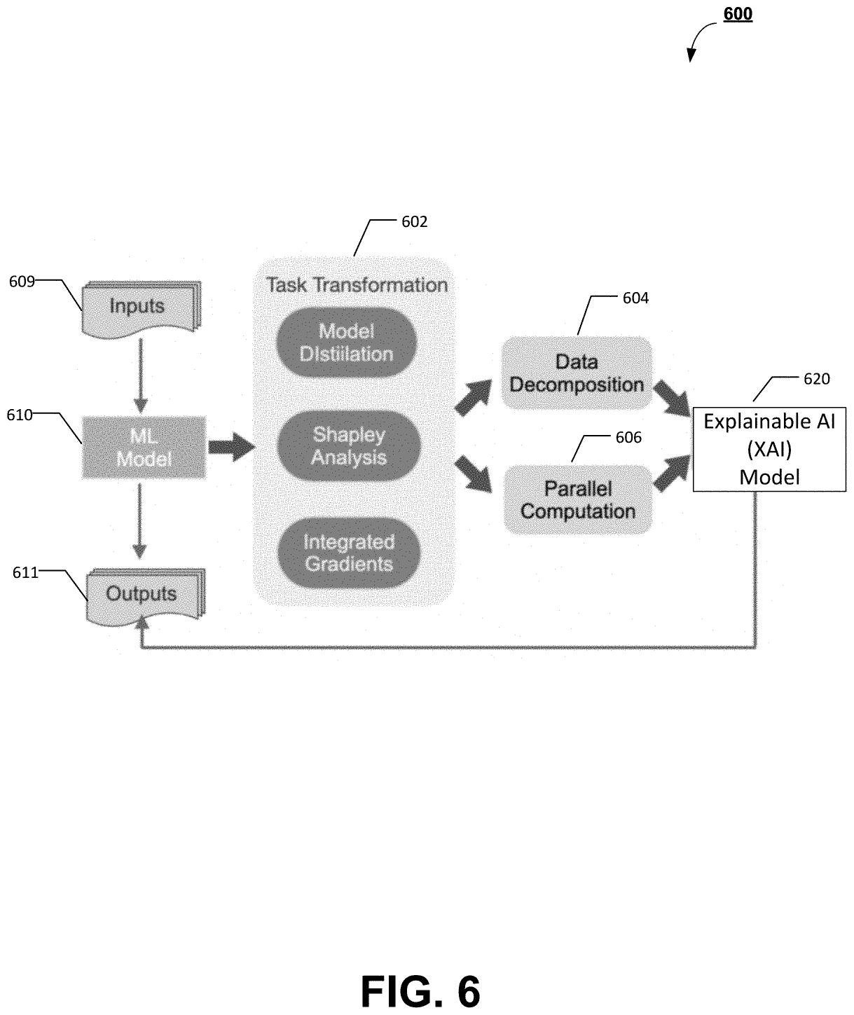

FIG. 6 illustrates an overview of an example framework 600 for hardware acceleration of explainable machine learning. The framework 600 may be used to provide explainability for a target machine learning model 610 via an explainable AI (XAI) model 620 configured to comprise, output, and/or otherwise indicate explainability data for the target machine learning model 610. For example, the XAI model 620 may indicate correlations between inputs 609 provided to the target machine learning model 610 and outputs 611 generated by the target machine learning model 610, thereby providing insight on learning and decisions made by the target machine learning model 610. In various embodiments, the XAI model 620 can be a distilled model generated in response to executing one or more of the methods described herein.

In various examples, the target machine learning model 610 is generated and trained via a training scheme (e.g., supervised learning, semi-supervised learning, unsupervised learning, self-supervised learning, and/or the like), and with the target machine learning model 610, an input-output dataset can be constructed. Generally, the input-output dataset includes the inputs 609 and corresponding outputs 611 generated by the target machine learning model 610 that represent its trained and learned inferences about the inputs 609.

As illustrated in the framework 600, a XAI model 620 is generated according to various embodiments of the present disclosure, and the XAI model 620 is configured to provide explainability data for the behavior of the target machine learning model 610. With the framework 600, the XAI model 620 is generated and developed in a rapid and/or efficient manner, such that the XAI model 620 can provide its explainability data within a real-time or near real-time ML-based system.

According to various embodiments of the present disclosure, the framework 600 includes three primary tasks to achieve fast model distillation: (i) task transformation 602, (ii) data decomposition 604, and (iii) parallel computation 606. In various embodiments, task transformation 602 is performed to define the generation of the XAI model 620 by transforming (e.g., converting and/or augmenting) at least one of one or more explainable ML techniques including model distillation techniques, Shapley analysis (SHAP) techniques, and/or Integrated Gradient (IG) techniques.

Then, data decomposition 604 and parallel computation 606 are performed as synergistic activities to accelerate the model distillation, or the Fourier transform operations. At data decomposition 604, the generation of the XAI model 620, represented by the Fourier transform operations, is divided into a plurality of sub-tasks, and each sub-task can be executed by a core or computing unit of an accelerated hardware element 506 (e.g., a streaming processor 204 of the GPU 200, a MXU 252 of the TPU 250). With parallel computation 606, multiple input-output pairs from the input-output dataset are processed concurrently, and the accelerated hardware elements 506 are configured to enable the parallel computation 606. In various examples, simultaneous or near simultaneous execution of data decomposition 604 and parallel computation 606 provides significant improvement in acceleration efficiency, as demonstrated in experimental evaluations in the present disclosure.

Task Transformation: As described, task transformation 602 generally comprises defining a plurality of Fourier transform operations configured to result in a XAI model 620 that provides explainability data for the target machine learning model 610. In various embodiments, the plurality of Fourier transform operations is performed with data objects, such as matrices, tensors, arrays, images, image stacks, and/or the like, that represent inputs 609 and outputs 611 for the target machine learning model 610. The XAI model 620 obtained from the plurality of Fourier transform operations is configured to be a lightweight “shadow” model to mimic the input-output mapping behavior of the target machine learning model 610, which may be comparatively complex and cumbersome.

In various embodiments, the XAI model 620 is associated with at least two requirements: simplicity and compatibility. In terms of simplicity, the XAI model 620 is lightweight and simple. Otherwise, in various examples, complexity at the XAI model 620 may result in difficulty for users to understand the behaviors of the XAI model 620, much less the behaviors of the target machine learning model 610. With respect to compatibility, the type or architecture of the XAI model 620 should be compatible with that of the target machine learning model 610. For instance, use of a fully-connected network as the XAI model 620 to approximate a target convolution neural network would lead to a loss of accuracy.

Accordingly, in various embodiments, a regression model is applied in order to satisfy the two requirements outlined above. Formally, given input data X and output data Y, a matrix K can be found according to Equation 4, in which “*” denotes a matrix convolution operation. That is, in various embodiments, the input data and the output data (e.g., inputs 609 and output 611) are defined in the form of matrices, tensors, arrays, images, and/or the like.

X*K=Y Equation 4

Since convolution is a linear-shift-invariant operation, the regression model in Equation 4 guarantees the XAI model to be sufficiently lightweight and transparent. Under this scenario, generating the XAI model boils down to solving for the parameters in matrix K.

To solve for K, one key observation is that the Fourier transformation can be applied on both sides of Equation 4, and by discrete convolution theorem, Equation 5 can be defined. In Equation 5, ∘ represents the Hadamard product, or an element-wise matrix product or multiplication operation.

[symbol]

(X*K)= [symbol] (Y)

[symbol]

(X)∘ [symbol] (K)= [symbol] (Y) Equation 5

Therefore, generation of the XAI model 620, or solving for K, can be given by Equation 6, in various embodiments.

$$K = {ℱ}^{- 1} ( \frac{ℱ ( Y )}{ℱ ( Y )} ) \qquad Equation 6$$

As discussed, the primary goal of explainable ML is to measure how each input feature contributes to the output value. Once K is obtained, the contribution of each feature can be viewed in an indirect way. Consider a scenario in which a component for an input feature is removed from the original input, and the modified input is passed through the XAI model 620 again to produce a “perturbed” result. Then by calculating the difference between the original and newly generated (perturbed) outputs of the XAI model 620, the impact of the key feature on the output can be quantified. The intuition behind the assumption is that hiding important features are more likely to cause considerable changes to the model output.

Formally, assume that the input is X=[x₁, x₂, . . . , xᵢ₋₁, xᵢ, xᵢ₊₁, . . . , x_{d}]. In various embodiments, a contribution factor of one input element xᵢ may be defined according to Equation 7.

$$con ( {x}_{i} ) {=}^{Δ} Y - {X}^{′} * K \qquad Equation 7$$

In Equation 7, X′=[x₁, x₂, . . . , xᵢ₋₁, 0, xᵢ₊₁, . . . , x_{d}], which mirrors X save for the removal of the target component (xᵢ).

Thus, as shown, generation of the XAI model 620 has been discretized into a plurality of Fourier transform operations and including a plurality of matrix convolution operations and point-wise division operations. In various embodiments, each type of discretized operation can be accelerated with accelerated hardware elements 506.

The transformation of one or more SHAP computations can be used to generate an XAI model (XAI model 620) and/or can be utilized for feature attribution to provide explainable ML in accordance with one or more embodiments of the present disclosure. In some embodiments, a SHAP value function can be expressed as a pseudo-Boolean function, and a corresponding formula can be obtained to calculate the Shapley value for graphical, cooperative games. Specifically, for every pseudo logical value function v, a structure vector Cᵥ∈ [symbol] ²^{ⁿ} can be found such that the SHAP value equation can be expressed into a matrix form as v(S)=Cᵥx^{s}. Then, according to the definition of the Shapley value (as provided in Equation 2), it can be derived that:

$$v ( S ⋃ \{ i \} ) - v ( S ) = {C}_{v} ( {x}_{i}^{S} … {x}_{i - 1}^{S} [ \begin{matrix}1 \\ 0\end{matrix} ] {x}_{i + 1}^{S} … {x}_{n}^{S} - {x}_{1}^{S} … {x}_{i - 1}^{S} [ \begin{matrix}0 \\ 1\end{matrix} ] {x}_{i + 1}^{S} … {x}_{n}^{S} )$$

As such, TPU can then be used to solve these system of equations.

The transformation of one or more IG computations can be used to generate an XAI model (XAI model 620) and/or can be utilized for feature attribution to provide explainable ML in accordance with one or more embodiments of the present disclosure. As described herein, the computation of IG is straightforward using Equation 3. In many circumstances, the output function F (e.g., as provided in Equation 3) is too complicated to have an analytically solvable integral. However, this challenge can be mitigated using two strategies. In the first strategy, numerical integration with polynomial interpolation can be applied to approximate the integral. In the second strategy, interpolation using the Vandermonde matrix can be performed to accommodate it to TPU.

The numerical integration is computed through the trapezoidal rule. Formally, the trapezoidal rule works by approximating the region under the graph of the function F(x) as a trapezoid and calculating its area to approach the definite integral, which is actually the result obtained by averaging the left and right Riemann sums. The interpolation improves approximation by partitioning the integration interval, applying the trapezoidal rule to each sub-interval, and summing the results. Let {xₖ} be the partition of [a, b] such that a<x₁<x₂ . . . x_{N-1}<x_{N}<b and let Δxₖ be the length of the k-th sub-interval, then

$${\int }_{a}^{b} F ( x ) dx \approx {\sum }_{k = 1}^{N} \frac{F ( {x}_{k - 1} + F ( {x}_{k} ) )}{2} Δ {x}_{k} \qquad Equation 8$$

In various embodiments, after the numerical integration with the polynomial interpolation has been applied to approximate the integral, interpolation using the Vandermonde matrix is computed to accommodate it to TPU. The basic procedure to determine the coefficients a₀, a₁, . . . , aₙ of a polynomial Pₙ(x)=a₀+a₁x+a₂x₂+aₙxⁿ such that it interpolates the n+1 points (x₀, y₀), (x₁, y₁), (x₂, y₂), . . . , (xₙ, yₙ) is to write a linear system as follows:

$${P}_{n} ( {x}_{0} ) = {y}_{0} ⇒ {a}_{0} + {a}_{1} {x}_{0} + {a}_{2} {x}_{0}^{2} + … {a}_{n} {x}_{0}^{n} = {y}_{0} \\ {P}_{n} ( {x}_{1} ) = {y}_{1} ⇒ {a}_{0} + {a}_{1} {x}_{1} + {a}_{2} {x}_{1}^{2} + … {a}_{n} {x}_{1}^{n} = {y}_{1} \\ {P}_{n} ( {x}_{2} ) = {y}_{2} ⇒ {a}_{0} + {a}_{1} {x}_{2} + {a}_{2} {x}_{2}^{2} + … {a}_{n} {x}_{2}^{n} = {y}_{2} \\ ⋮ ⇒ ⋮ \\ {P}_{n} ( {x}_{n} ) = {y}_{n} ⇒ {a}_{0} + {a}_{1} {x}_{n} + {a}_{2} {x}_{n}^{2} + … {a}_{n} {x}_{n}^{n} = {y}_{n}$$

Or, in matrix form:

$$[ \begin{matrix}1 & {x}_{0} & {x}_{0}^{2} & … & {x}_{0}^{n - 1} & {x}_{0}^{n} \\ 1 & {x}_{1} & {x}_{1}^{2} & … & {x}_{1}^{n - 1} & {x}_{1}^{n} \\ 1 & {x}_{n - 1} & {x}_{n - 1}^{2} & … & {x}_{n - 1}^{n - 1} & {x}_{n - 1}^{n} \\ ⋮ & ⋮ & ⋮ & ⋮ & ⋮ & ⋮ \\ 1 & {x}_{n} & {x}_{n}^{2} & … & {x}_{n}^{n - 1} & {x}_{n}^{n}\end{matrix} ] [ \begin{matrix}{a}_{0} \\ {a}_{1} \\ ⋮ \\ {a}_{n - 1} \\ {a}_{n}\end{matrix} ] = [ \begin{matrix}{y}_{0} \\ {y}_{1} \\ ⋮ \\ {y}_{n - 1} \\ {y}_{n}\end{matrix} ]$$

The left matrix V is the Vandermonde matrix. As shown, V is non-singular, thus the system can be solved using TPU to obtain the coefficients.

Data Decomposition: In various embodiments, data decomposition 604 involves disentangling and distributing the plurality of Fourier transform operations among computation resources to significantly accelerate performance of the plurality of Fourier transform operations.

The general form of a 2-D Discrete Fourier Transform (DFT) applied on an M×N signal may be defined according to Equation 9, in which k=0, . . . , M−1, and l=0, . . . , N−1.

$$X [ k , l ] = \frac{1}{\sqrt{MN}} {\sum }_{n = 0}^{N - 1} [ {\sum }_{m = 0}^{M - 1} x [ m , n ] {e}^{- j 2 π ( \frac{mk}{M} )} ] {e}^{- j 2 π ( \frac{nl}{N} )} \qquad Equation 9$$

In various embodiments, an intermediate signal X′ may be defined, and in some examples, the intermediate signal X′ is defined according to Equation 10.

$${X}^{′} [ k , n ] {=}^{Δ} \frac{1}{\sqrt{M}} {\sum }_{m = 0}^{M - 1} x [ m , n ] {e}^{- j 2 π ( \frac{mk}{M} )} \qquad Equation 10$$

The intermediate signal may then be incorporated within the general form of the 2-D DFT. For example, Equation 10 may be plugged into Equation 9 to arrive at Equation 11.

$$X [ k , l ] = \frac{1}{\sqrt{N}} {\sum }_{n = 0}^{N - 1} {X}^{′} [ k , n ] {e}^{- j 2 π ( \frac{nl}{N} )} \qquad Equation 11$$

As may be recognized, Equation 10 exhibits similarities with the definition of a 1-D Fourier transform applied on a M-length vector, with said definition being shown in Equation 12.

$$X [ k ] = \frac{1}{\sqrt{M}} {\sum }_{m = 0}^{M - 1} x [ m ] {e}^{- j 2 π ( \frac{mk}{M} )} \qquad Equation 12$$

If n is set as a fixed parameter, then the application of Equation 10 becomes at least approximately equivalent to performing a 1-D Fourier transform on the n-th column of the original input M×N matrix. In various examples, the 1-D Fourier transform can be represented as a product of an input vector and a Fourier transform matrix. Thus, Equation 10 can then be equivalently represented by Equation 13.

X′[k,n]=W_{M}·x[m,n] Equation 13

In Equation 13, W_{M} represents a M×M Fourier transform matrix. By varying n from 1 to N−1 and showing the results side by side, Equation 14 can be defined.

X′=[X′[k,0], . . . ,X′[k,N−1]]=W_{M}·x Equation 14

In various embodiments, k can be treated as a parameter, and with viewing the definition of X′[k, n] as the 1-D Fourier transform with respect to the k-th row of input x, Equation 15 can be defined. In Equation 15, W_{N} represents a N×N Fourier transform matrix.

X=X′·W_{N} Equation 15

Then, with combining Equation 14 and Equation 15, Equation 16 can be derived to define a final expression for X.

X=(W_{M}·x)·W_{N} Equation 16

This transformed expression provided by Equation 16 indicates that, according to various embodiments of the present disclosure, a 2-D Fourier transform can be achieved in a two-stage manner. First, all the rows of an input x may be transformed to obtain an intermediate result X′. Second, all of the columns of the intermediate result X′ may be transformed to obtain the final result X. An important observation is that the required computation for each row/column is completely independent. This implies that in real implementation, the computation process can be reliably, effectively, and accurately split into computational sub-threads. Given p number of involved or recruited individual processing cores and an input of dimensions M×N, each processing core is assigned at most

$$\frac{max \{ M , N \}}{p}$$

1-D Fourier transforms workload, and each processing core of an accelerated hardware element 506 can execute in parallel, according to various embodiments. In various embodiments, merging the results of the processing cores exactly matches the desired 2-D Fourier transform result. Algorithm 1 outlines one example embodiment of data decomposition in accordance with the description above.

Algorithm 1: Acceleration of Fourier Transform

```
Input : M × N matrix x, number of individual cores
      p
Output: 2D Fourier Transform result X
Initialize each core c₁, c₂, ...cₚ
X = 0
for each i ∈ [0, ..., p − 1] do
  | Split M/p rows xᵢ from x
  |_ X [symbol]  = Execute(e [symbol]   , xᵢ)
Merge Results: X′ = [X₁′, X₂′, ..., Xₚ′] [symbol]
for each j ∈ [0, ..., p − 1] do
  | Split N/p columns x′ⱼ from X′
  |_ Xⱼ= Execute(eⱼ, x′ⱼ)
Merge Results: X = [X₁, X₂, .... Xₚ]
return X
procedure Execute(e [symbol]   , x [symbol]   )
res = 0
for each r ∈ x [symbol]    do
  |_ r′ = [symbol]  (r)
res = merge(res, r)
return res
endprocedure
```

[symbol]

indicates data missing or illegible when filed

Parallel Computation: In addition to exploiting hardware to accelerate performance of Fourier transform operations, parallel computation 606 is utilized to further improve the time efficiency. In various embodiments, the input-output dataset obtained from the target machine learning model 610 may include a large volume of input-output pairs that each require processing to generate the XAI model 620. The above-described technique of data decomposition 604 is applied on each individual input such that the computation cost is distributed among several cores of one or more accelerated hardware elements 506. Then, data decomposition 604 for a single input is extended with parallel computation 606 such that multiple inputs can be simultaneously or near-simultaneously processed (e.g., decomposed).

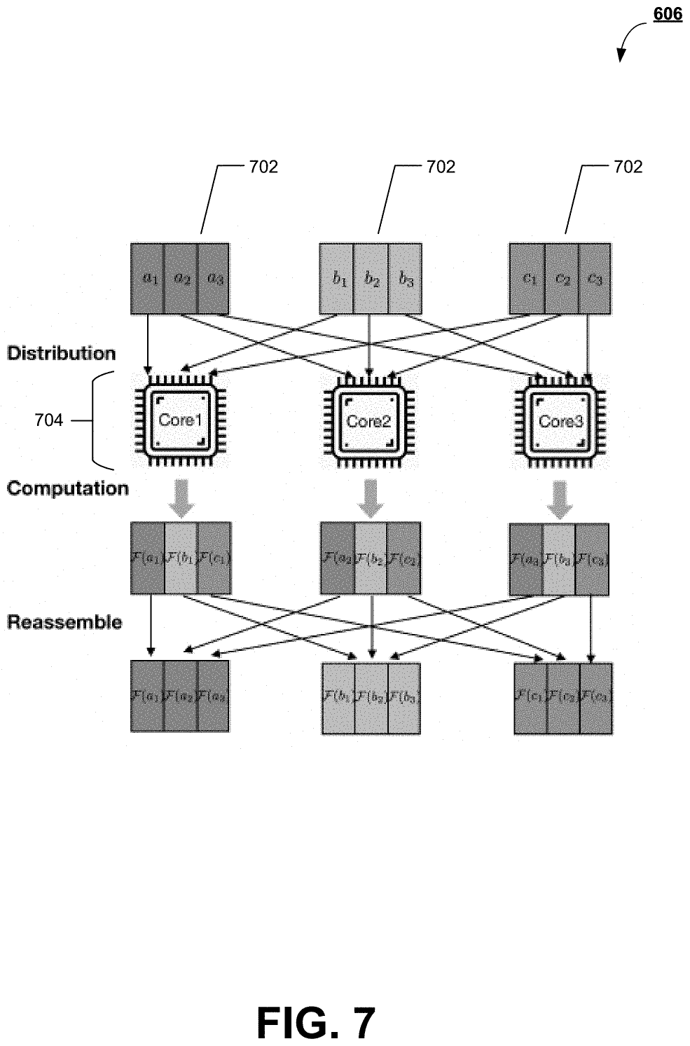

An illustrative example of parallel computation 606 in accordance with various embodiments of the present disclosure is shown in FIG. 7. In the illustrated embodiment, the goal is to perform 1-D Fourier transform operations on each column of input matrices 702, as defined by data decomposition 604. First, each input matrix is segmented into pieces and each core 704 obtains a slice of them. In the illustrated embodiment, three input matrices 702 are segmented into a total of nine slices or pieces: a₁, a₂, a₃, b₁, b₂, b₃, c₁, c₂, and c₃. Next, each piece is assigned to an individual core to perform the Fourier transform operation. In the illustrated embodiment, three cores (Core1, Core2, Core3) are illustrated, and in various embodiments, each core 704 may be embodied by a streaming processor 204 of a GPU 200, a MXU 252 of a TPU 250, and/or the like.

In various embodiments, an internal table is generated and utilized during computation to keep track of the distribution of input data portions (e.g., slices of the input matrices 702) among the cores 704 to guide reassembly of the outputs. As illustrated in FIG. 7, the outputs of the cores 704 are reassembled, for example, to arrive at the Fourier transform of the input matrices 702 simultaneously or near simultaneously.

In addition to the Fourier transform operations, parallel computation 606 can be applied to the matrix multiplication operations involved in generating the XAI model 620. In particular, with parallel computation 606, a matrix multiplication operation essentially becomes a block matrix multiplication operation, in which original matrices are partitioned into small blocks. The small blocks are multiplied and merged appropriately afterwards (e.g., in accordance with the internal table). Thus, matrix multiplication operations similarly enjoy improved performance efficiency from parallel computation 606.

In various embodiments, communication among the separate processing cores 704 occurs at every iteration of the reassembly process to compute the summation of the partial matrices across the cores 704. In some examples, for example, cross-core communication may be implemented with a tf.cross_replica_sum function and/or a like function. The data decomposition 604 and the parallel computation 606 or implementation not only efficiently utilizes the strength in matrix multiplication of accelerated hardware elements 506 but also requires minimal communication time, which leads to drastic improvement in acceleration performance. Thus, through data decomposition 604 and parallel computation 606, generation as well as interpretation of the XAI model 620 (in accordance with Equations 6 and 7, respectively) is significantly accelerated.

### IV. Example Experimental Implementation of Various Embodiments

Hardware acceleration of explainable machine learning and the effectiveness thereof in accordance with various embodiments described herein is experimentally evaluated herein. Experiments were conducted on a host machine with Intel i7 3.70 GHz CPU, equipped with an external NVIDIA GeForce RTX 2080 Ti GPU (embodying an accelerated hardware element 506). Google's Colab platform was utilized to access Google Cloud TPU service. In the evaluation, the TPUv2 (also embodying an accelerated hardware element 506) with 64 GB High Bandwidth Memory (HBM), and 128 TPU cores was used. Code for model training was developed using Python, with PyTorch 1.6.0 as the machine learning library. In the experimental evaluation, two benchmarks were defined: (1) the VGG19 classifier for CIFAR-100 image classification, and (2) the ResNet50 network for MIRAI malware detection.

Three hardware configurations were used to highlight the technical effects of various embodiments of the present disclosure. To address the compatibility of Algorithm 1, all the framework tasks—task transformation 602, data decomposition 604, parallel computation 606—were deployed on all three hardware configurations. The three hardware configurations included: (1) CPU, which represents traditional execution in software herein identified as the baseline method, (2) GPU (NVIDIA GeForce 2080 Ti GPU as identified above), and (3) TPU (Google's cloud TPU as identified above).

The model training process comprised 500 epochs in total, with a mini-batch size of 128. As for result evaluation, classification performance was first evaluated by reporting classification accuracy and execution time of the benchmark ML models. Next, energy performance of various embodiments described herein was evaluated by measuring its performance per watt on each hardware, and power consumption under different workloads was further recorded. Then, the average time for completing outcome interpretation step for each configuration is reported herein. Finally, the effectiveness in interpreting classification results of hardware-accelerated explainable ML according to various embodiments is presented.

Table II compares the classification time and accuracy. Each row represents a specific model structure trained with corresponding hardware configuration. For both training time and testing time, each entry represents time cost of 10 epochs on average. As shown, with sufficient number of training epochs, all acceleration techniques obtain reasonable classification accuracy. However, when it comes to time-efficiency, the CPU-based baseline implementation lags far behind the other two, which achieved the slowest speed. On VGG19, GPU-based acceleration provides the best acceleration performance, which provides 65× speedup compared to the baseline implementation. This clearly indicates the great compatibility between accelerated hardware elements 506 and their described use in various embodiments. In case of ResNet50, an even higher speedup was obtained by TPU-based acceleration, showing its acceleration potential in large scale neural networks by providing around four times speedup than GPU-based acceleration. The drastic improvement (44.5×) compared to the baseline method also leads to significant energy savings.

TABLE II
Comparison of accuracy and classification time for various benchmarks

| | CPU-based Acceleration | | | GPU-based Acceleration | | | TPU-based Acceleration | | | | |
|---|---|---|---|---|---|---|---|---|---|---|---|
| | Accuracy | Training- | Testing- | Accuracy | Training- | Testing- | Accuracy | Training- | Testing- | Speedup./ | Speedup./ |
| bench | (%) | time(s) | time(s) | (%) | time(s) | time(s) | (%) | time(s) | time(s) | CPU | GPU |
| VGG19 | 94.06 | 24.2 | 10.9 | 92.08 | 0.25 | 0.08 | 96.37 | 0.4 | 0.14 | 65x | 0.61x |
| ResNet50 | 78.99 | 176.2 | 129.8 | 86.87 | 19.1 | 9.4 | 87.47 | 4.3 | 2.6 | 44.5x | 4.13x |
| Average | 86.52 | 100.2 | 70.35 | 89.47 | 9.67 | 4.84 | 91.92 | 2.35 | 1.37 | 54.7x | 3.9x |

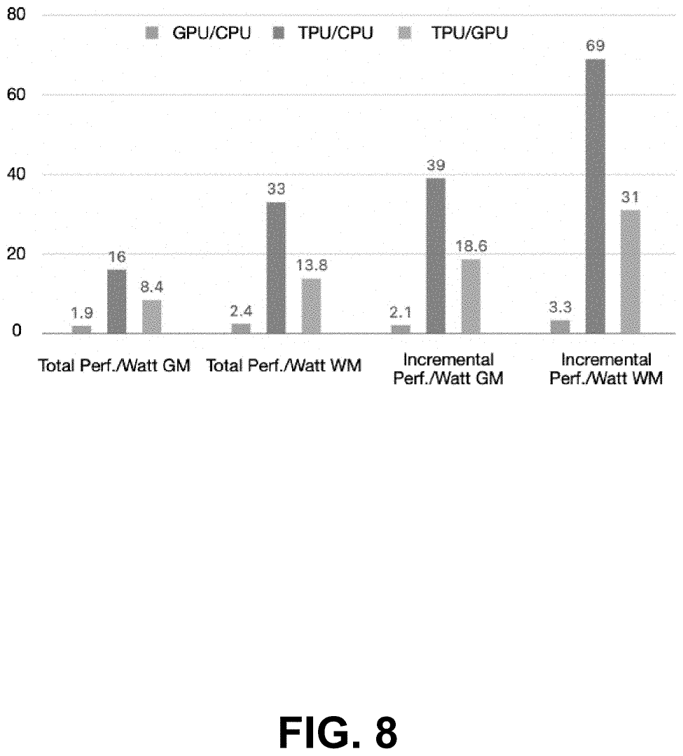

Power consumption is another important aspect of performance evaluation, as power closely affects the thermal, provision and stability of the device. Consequently, designers must supply sufficient power consideration for methods deployed on hardware components to ensure their power constraints are satisfied. FIG. 8 shows the geometric and weighted mean performance/Watt for the GPU and the TPU relative to the CPU. Power consumption is calculated in two different ways. The first one (referred as “total”) computes the total power consumption which represents the power consumed by the host CPU as well as the actual execution performance/Watt for the GPU or the TPU. The second one (referred as “incremental”) does not consider the host CPU power, and therefore, it reflects the actual and isolated power consumption of the GPU or the TPU during acceleration. As shown in FIG. 8, for total-performance/watt, the GPU implementation is 1.9× and 2.4× better than baseline CPU for geometric mean (GM) and weighted mean (WM), respectively. TPU outperforms both CPU (16× on GM and 33× on WM) and GPU (8.4× on GM and 13.8× on WM) in terms of total performance/watt. For incremental-performance/watt, when host CPU's power is omitted, the TPU shows its dominance in energy efficiency over both CPU (39× on GM and 69× on WM) and GPU (18.6× on GM and 31× on WM).

Thus, in terms of energy efficiency, the TPU-based acceleration is most advantageous, followed by the GPU-based acceleration and then the CPU baseline. Various embodiments of the present disclosure fully utilizes data decomposition to create a high-level parallel computing environment where both GPU and TPU benefit from balancing workloads on every single core. Although both GPU and TPU have the advantage of utilizing parallel computing to fulfill the proposed framework, TPU provides better performance/watt primarily due to the quantification property of TPU, which powerfully reduces the cost of neural network prediction as well as the reduction in memory.

As mentioned previously, the use of integers instead of floating point calculations greatly reduces the hardware size and power consumption of the TPU. Specifically, TPU can perform 65,536 8-bit integer multiplications in a cycle, while example GPUs used in cloud environments can perform few thousands of 32-bit floating-point multiplications. As long as 8 bits can be used to meet the accuracy requirements, it can bring significant performance improvement. While both TPU and GPU based acceleration can achieve fast explainable machine learning, the TPU-based implementation is the best in terms of energy efficiency, in various examples.

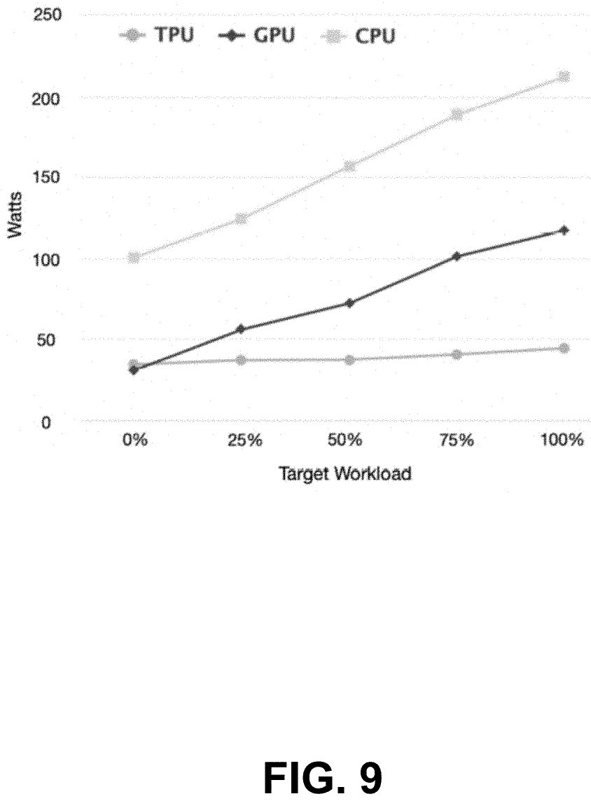

FIG. 9 illustrates a further evaluation of the power performance of three configurations (CPU, GPU and TPU) under different workloads. The power consumption in Watts for the three scenarios was measured when generating distilled models in accordance with various embodiments described herein. Next, the overall statistics to each single core were normalized to ensure fair comparison. FIG. 9 shows that the TPU has the lowest power consumption (40 W on average).

Next, the efficiency of various embodiments on explaining ML models is demonstrated. The average time for performing outcome interpretation for every 10 input-output pairs using model distillation is presented in Table III. The VGG19 result demonstrates that the TPU method obtains the best result as it is 36.2× and 1.9× faster than CPU and GPU based implementations, respectively. As expected, the improvements are even higher in case of ResNet50, where 39.5× and 4.78× speedup obtained over CPU and GPU based approaches, respectively. Since the outcome interpretation procedure can be completed in few seconds, various embodiments enable embedding of explainable ML during model training in diverse applications.

TABLE III
Average time (seconds) for outcome interpretation
using Model Distillation

| Model | CPU | GPU | TPU | Impro./CPU | Impro./GPU |
|---|---|---|---|---|---|
| VGG19 | 550.7 | 29 | 15.2 s | 36.2x | 1.9x |
| ResNet50 | 1456.1 | 176 | 36.8 s | 39.5x | 4.78x |
| Average | 1003.4 | 102.5 | 26.0 | 38.6x | 3.94x |

The average time for performing outcome interpretation for every 10 input-output pairs using SHAP values is presented in Table IV. The VGG19 result demonstrates that the TPU method obtains the best result as it is 16× and 3× faster than CPU and GPU based implementations, respectively. Improvements are also made in the case of ResNet50 as well, where 4.5× and 3.2x speedup are obtained over CPU and GPU based approaches, respectively.

TABLE IV
Average time (seconds) for outcome interpretation
using Shapley Values

| Model | CPU | GPU | TPU | Impro./CPU | Impro./GPU |
|---|---|---|---|---|---|
| VGG19 | 580.2 | 77.1 | 18.3 | 16x | 3x |
| ResNet50 | 50.1 | 11.6 | 3.8 s | 4.5x | 3.2x |
| Average | 365.4 | 44.5 | 11.6 | 5.8x | 2.4x |

The average time for performing outcome interpretation for every 10 input-output pairs using IG is presented in Table V. The VGG19 result demonstrates that the TPU method obtains the best result as it is 25.7× and 3.8× faster than CPU and GPU based implementations, respectively. Improvements are also made in the case of ResNet50 as well, where 10.8× and 2x speedup are obtained over CPU and GPU based approaches, respectively.

TABLE V
Average time (seconds) for outcome interpretation
using Integrated Gradients

| Model | CPU | GPU | TPU | Impro./CPU | Impro./GPU |
|---|---|---|---|---|---|
| VGG19 | 443.1 | 17.2 | 4.5 | 25.7x | 3.8x |
| ResNet50 | 17.3 | 1.6 | 0.8 | 10.8x | 2x |
| Average | 230.2 | 9.4 | 11.6 | 18.2x | 2.9x |

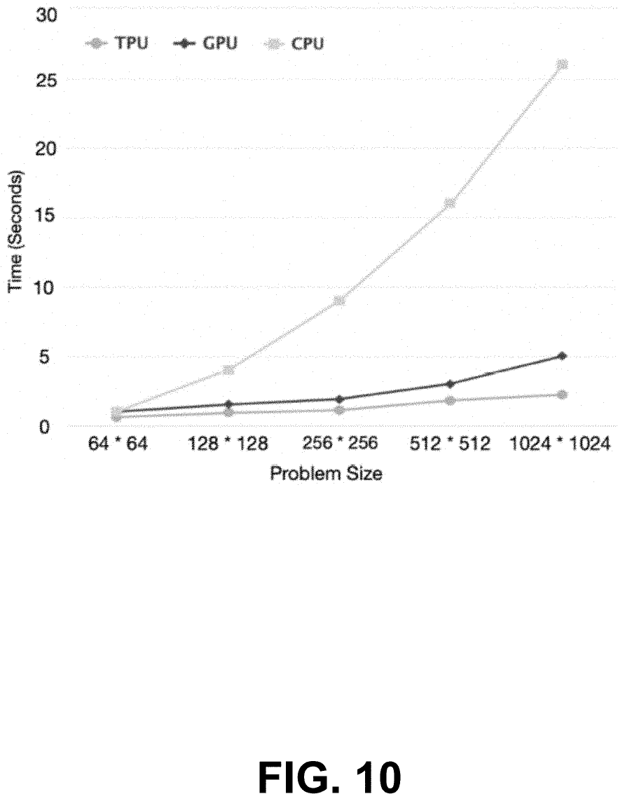

To demonstrate the scalability of various embodiments, several matrices with varying sizes are randomly selected and compared with respect to time efficiency, as shown in FIG. 10. It is expected that the time will increase with the increase in the size of the matrices. FIG. 10 shows that implementations on GPU and TPU based architectures are scalable across various problem sizes. In various embodiments, there are at least two reasons for the scalability. First, various embodiments utilize data decomposition 604 to break larger matrices into smaller sub-matrices. Second, these smaller sub-matrices are distributed across multiple cores. This drastically reduces the bandwidth requirement during the computation and leads to a significant improvement in computation speed. For matrices in the size of 1024×1024, the TPU-based implementation performs more than 30× faster than the baseline implementation. This indicates that for training and outcome interpretation on large-scale neural networks (with tens of thousands of matrix operations), the TPU-based implementation can save hours of computation time, which also leads to significant energy savings.

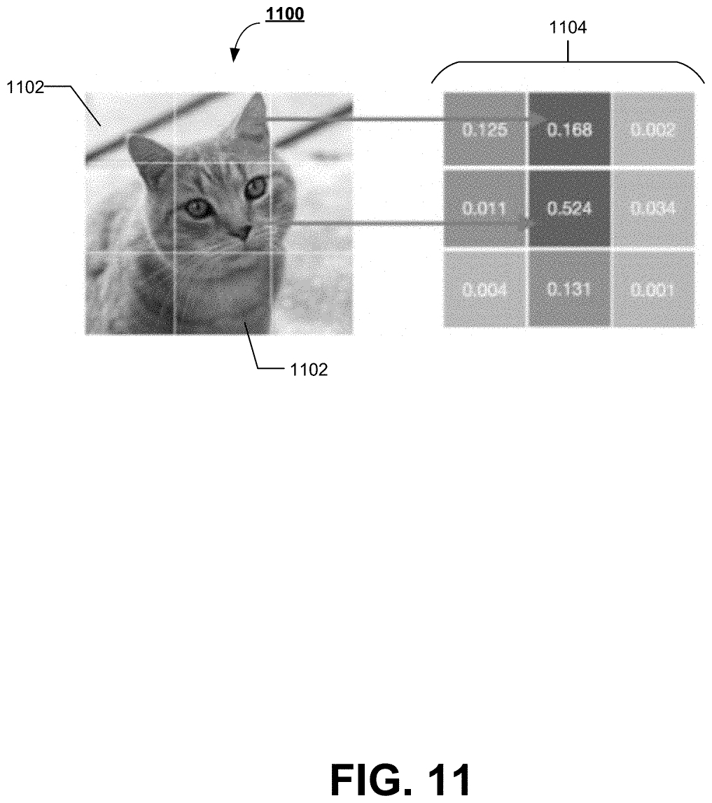

Since hardware components are used for accelerating explainable ML, various embodiments not only achieved faster classification in various examples, but also provide effective explanation of classification results. Outcome interpretation in a wide variety of scenarios is evaluated herein. Here, two examples of outcome interpretation from two different domains— image classification and malware detection—are provided. As expected from the above analysis, the interpretation time is only few seconds. FIG. 11 shows an example of interpreting the classification results for an example picture 1100 from the CIFAR-100 dataset. The picture 1100 is segmented into nine square sub-blocks 1102. The framework 600 was applied to compute a contribution factor 1104 (e.g., according to Equation 7) of each individual sub-block 1102 towards the classifier's output, so that it can illustrate what part is crucial for the classifier to distinguish it from other categories. In the given picture, the cat's face (central block) and ear (mid-up block) are the keys to be recognized as cat, as indicated via their relatively significant contribution factors 1104.

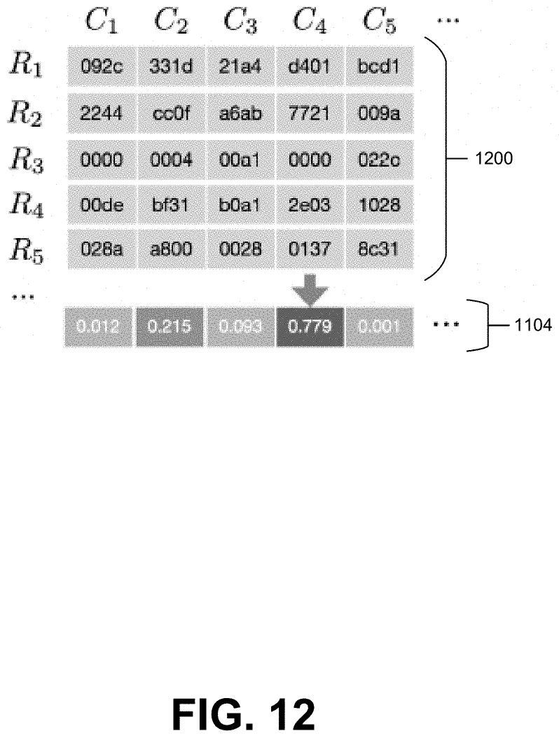

Turning now to FIG. 12, an example on malware detection from a ML-based detector, ResNet50, is provided. The ML-based detector receives running data of Mirai malware as input in the format of a trace table 1200, where each row represents the hex values in a register in specific clock cycles and each column represents a specific clock cycle. FIG. 12 shows an example of the trace table 1200.

The corresponding contribution factor 1104 of each clock cycle towards the output is generated in an efficient and simultaneous manner in accordance with various embodiments described herein. Contribution factors 1104 are shown as weights in the row of values below the trace table 1200. Clearly, it can be seen that the contribution factor 1104 of C₂ is significantly larger than those of some of the other clock cycles. By tracing the execution, it was shown that C₂ corresponded to the timestamp of assigning value to the variable ATTACK_VECTOR in Mirai. This variable records the identity of attack modes, based at least in part on which the Mirai bot takes relative actions to perform either a UDP attack or DNS attack. This attack-mode flag is the most important feature of a majority of malware bot programs, and as demonstrated, various embodiments were able to successfully extract it from the traces to illustrate the explainable and interpretable reason for classifying it as a malware. Accordingly, various embodiments can be applied to not only provides confidence in malware detection, but also to assist in malware localization.

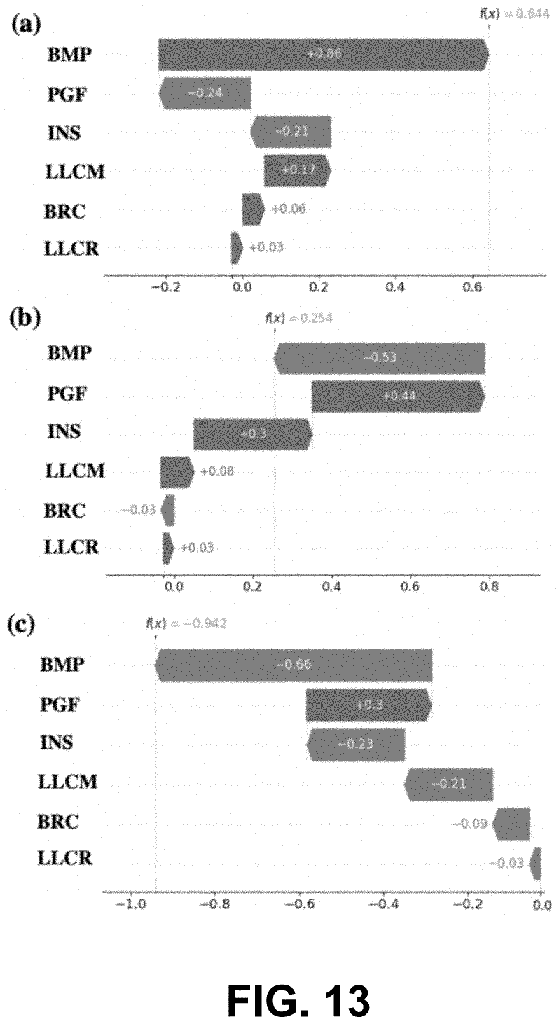

Turning now to FIG. 13, the outcome of interpretation through Shapley value analysis for a classification task is illustrated via the waterfall plot of SHAP values from three samples. Specifically, FIG. 13, illustrates the SHAP values for three example cases. Waterfall plot (a) illustrates a Spectre attack program example, waterfall plot (b) illustrates a Meltdown attack example, and waterfall plot (c) illustrates a benign program. The SHAP values clearly illustrate the major features that lead to the model output. Waterfall plots (a) and (b) are true positive samples, and waterfall plot (c) is a true negative sample. The waterfall plots demonstrate the contribution of each feature and how the features affect the decision of the model. The plus or minus signs illustrate whether the specific feature is supporting (e.g., voting) the sample to be positive (e.g., depicted by the red bars), or supporting the sample to be negative (e.g., depicted by the blue bars). The SHAP values along with each bar show the exact impact of the SHAP values, and the summation of all SHAP values is compared with the threshold to give the final decision.

As shown in FIG. 13, branch mispredictions (BMP) and total page faults (PGF) are among the most important features. Note that in both waterfall plots (a) and (b), the selected attack programs are adversarial samples. In waterfall plot (a), we page faults are intentionally introduced to interfere with the feature pattern, as the PGF feature provides negative contribution to the final decision. Nevertheless, the waterfall plots clearly illustrate that the various embodiments of the present disclosure are still able to assign larger weights to the BMP feature so that embodiments can correctly predict the attack. In waterfall plot (b), redundant non-profit loops have been intentionally inserted to create additional branch mispredictions. The redundant branch mispredictions introduce the biggest negative contribution for the BMP feature to the model's prediction. Since the total number of instructions are also increased, the proposed model is able to produce correct predictions with the help of the total instruction numbers, reflected by the positive contribution from INS.

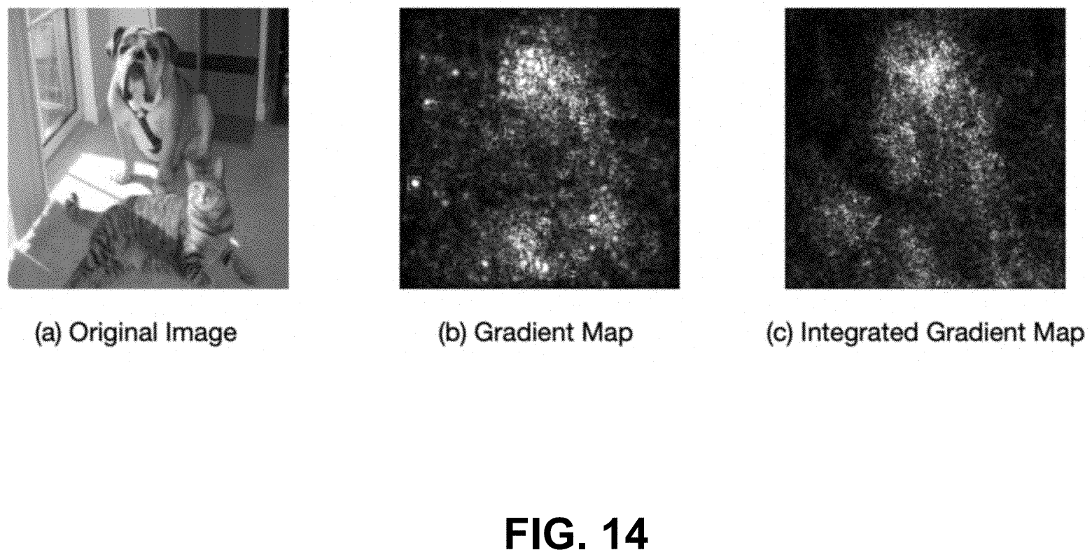

Turning now to FIG. 14, the outcome interpretation through IG for an image classification example. The results demonstrated in FIG. 14 depict (a) the original image, (b) the gradients map of the original image, and (c) the integrated gradients map of the given image. In the gradients maps ((b) & (c)), the lightness of pixels represents their contribution towards the model's decision. As a result, the model's outcome can be explained by highlighting the pixels that are the most reactive and likely to quickly change the output. As shown in (b) of FIG. 14, traditional gradient values cannot accurately reflect the distinguishing features from the input and can be easily disturbed by noise which induces a random scattering of attribution values. In contrast, the completeness axiom of IGs (e.g., as previously define herein) gives a stronger and more complete representation (e.g., explanation) of what went into the output. This is because the gradients received for saliency maps are generally in the model's saturated region of gradients.

### CONCLUSION

Various embodiments address technical challenges related to inefficiencies of existing explainable machine learning techniques that rendered them infeasible or at least severely restricted their applicability in many domains. Various embodiments utilize hardware-based acceleration to provide explainability, interpretability, and transparency to target machine learning models in a reasonable time. In various embodiments, explainability is provided via a distilled model that is generated with improved and significant efficiency through definition of a plurality of Fourier transform operations that arrive at the distilled model. The Fourier transform operations and other auxiliary matrix-based operations (e.g., matrix multiplication) are distributed among a plurality of cores or computing units of one or more accelerated hardware elements, such that multiple operations for processing of multiple input-output pairs associated with a target machine learning model can be performed simultaneous or near-simultaneously. In various other embodiments, explainability is provided via an explainable AI (XAI) model that is generated in part by augmenting explainable ML techniques such as Shapley analysis (SHAP) and integrated gradients (IG). As such, various embodiments enable implementation of explainable machine learning in a wide range of domains, including real-time and near real-time applications.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A method for acceleration of explainable machine learning techniques, the method comprising:
receiving, by one or more processors, a plurality of input-output data pairs associated with a target machine learning (ML) model;
generating, by the one or more processors, a plurality of data slices for each input-output data pair;
distributing, by the one or more processors, the plurality of data slices for each input-output data pair across a plurality of processing cores associated with one or more accelerated hardware elements; and
generating, by the one or more processors, an explainable artificial intelligence (XAI) model for the target machine learning model based at least in part on causing performance of at least a Fourier transform operation on each data slice at each processing core of the one or more accelerated hardware elements in a parallel or near-parallel manner, wherein the XAI model is used to provide explainability data associated with the target ML model.

2. The method of claim 1, wherein the XAI model is configured as at least one of a distilled model, a Shapley value analysis-based model, or an integrated gradient-based model, and wherein the XAI model is configured to be transformed into at least one matrix representation.

3. The method of claim 2, wherein the XAI model is configured as a distilled model, and wherein the distilled model is generated based at least in part on assembling distributed outputs generated by the plurality of processing cores via the performance of at least the Fourier transform operation for each data slice.

4. The method of claim 3, wherein the distributed outputs generated by the plurality of processing cores are assembled according to an internal table configured to describe the distribution of the data slices across the plurality of processing cores.

5. The method of claim 1, wherein the plurality of data slices comprise individual rows of an input matrix and an output matrix of each input-output data pair.

6. The method of claim 1, wherein each processing core is caused to perform a row-wise Fourier transform operation followed by a column-wise Fourier transform operation for each data slice.

7. The method of claim 1, wherein the explainability data is provided based at least in part on comparing a XAI model output responsive to an ML model input with a ML model output generated by the target ML model.

8. The method of claim 7, wherein the explainability data comprises a contribution factor for each input feature of the ML model input.

9. The method of claim 2, wherein the XAI model is configured as a distilled model, and wherein the distilled model is a linear regression representation of the target ML model.

10. The method of claim 1, wherein the one or more accelerated hardware elements comprise one or more graphics processing units (GPU) configured for efficiently performing matrix multiplication operations in parallel.

11. The method of claim 1, wherein the one or more accelerated hardware elements comprise one or more tensor processing units (TPU) configured for rapid matrix multiplication operations.

12. The method of claim 1, wherein the one or more accelerated hardware elements comprise one or more field programmable gate arrays (FPGAs).

13. The method of claim 1, wherein the one or more processors are in electronic communication with the one or more accelerated hardware elements via a bus.

14. A system comprising one or more processors, memory, and one or more programs stored in the memory, the one or more programs comprising instructions configured to cause the one or more processors to:
receive a plurality of input-output data pairs associated with a target machine learning (ML) model;
generate a plurality of data slices for each input-output data pair;
distribute the plurality of data slices for each input-output data pair across a plurality of processing cores associated with one or more accelerated hardware elements; and
generate an explainable artificial intelligence (XAI) model for the target machine learning model based at least in part on causing performance of at least a Fourier transform operation on each data slice at each processing core of the one or more accelerated hardware elements in a parallel or near-parallel manner, wherein the XAI model is used to provide explainability data associated with the target ML model.

15. The system of claim 14, wherein the XAI model is configured as at least one of a distilled model, a Shapley value analysis-based model, or an integrated gradient-based model, and wherein the XAI model is configured to be transformed into at least one matrix representation.

16. The system of claim 15, wherein the XAI model is configured as a distilled model, and wherein the distilled model is generated based at least in part on assembling distributed outputs generated by the plurality of processing cores via the performance of at least the Fourier transform operation for each data slice.

17. The system of claim 16, wherein the distributed outputs generated by the plurality of processing cores are assembled according to an internal table configured to describe the distribution of the data slices across the plurality of processing cores.

18. The system of claim 14, wherein the plurality of data slices comprise individual rows of an input matrix and an output matrix of each input-output data pair.

19. The system of claim 14, wherein each processing core is caused to perform a row-wise Fourier transform operation followed by a column-wise Fourier transform operation for each data slice.

20. An apparatus, the apparatus comprising at least one processor and at least one memory, the at least one memory having computer-coded instructions therein, wherein the computer-coded instructions are configured to, in execution with the at least one processor, cause the apparatus to:
receive a plurality of input-output data pairs associated with a target machine learning (ML) model;
generate a plurality of data slices for each input-output data pair;
distribute the plurality of data slices for each input-output data pair across a plurality of processing cores associated with one or more accelerated hardware elements; and
generate an explainable artificial intelligence (XAI) model for the target machine learning model based at least in part on causing performance of at least a Fourier transform operation on each data slice at each processing core of the one or more accelerated hardware elements in a parallel or near-parallel manner, wherein the XAI model is used to provide explainability data associated with the target ML model.
